(19) United States
(12) Patent Application Publication
(10) Pub. No.: US 2017/0300541 A1
(43) Pub. Date: Oct. 19, 2017

(54) ANALYTIC RESULTS MANAGEMENT DATABASE

(71) Applicant: Counsyl, Inc., South San Francisco, CA (US)

(72) Inventors: Peter B. KRENESKY, Vancouver, WA (US); Kevin R. HAAS, Berkeley, CA (US)

(21) Appl. No.: 15/488,120

(22) Filed: Apr. 14, 2017

Related U.S. Application Data
(60) Provisional application No. 62/323,413, filed on Apr. 15, 2016.

(51) Int. Cl. G06F 17/30

(52) U.S. Cl. CPC G06F 17/30563; G06F 17/30569; G06F 17/303; G06F 17/30365; G06F 17/3051

(57) ABSTRACT

According to one aspect, systems and processes for managing stored genomic sequencing data are provided. In exemplary process, a trigger related to a call review event is detected, where at least one portion of a denormalized data structure is accessed based on the detected trigger. In response the accessing, the at least one portion of the denormalized data structure is transformed into a normalized data structure. A user request associated with the at least one portion of the denormalized data structure is received. The normalized data structure is accessed in response to the user request, and information contained within the normalized data structure is then displayed on a display screen.

### CROSS-REFERENCE TO RELATED APPLICATIONS

This application claims priority to U.S. Provisional Ser. No. 62/323,413, filed on Apr. 15, 2016, entitled “ANALYTIC RESULTS MANAGEMENT DATABASE,” and is incorporated herein by reference for all purposes.

### FIELD

The following disclosure relates generally to an analytic results management database for managing information pertaining to a plurality of biological or genetic samples.

### BACKGROUND

New discoveries and developments in the areas of DNA sequencing have led to the creation of vast amounts of information which, in turn, have led to a growing need to efficiently store, retrieve, and process such data. Traditional methods of storing and processing sequencing data, for example, using conventional “spreadsheet” software in combination with compatible text files (e.g., Variant Call Format files), is an increasingly obsolete methodology for handling this growing volume of data. Given the complexity of stored sequencing information, even conventional software designed for processing this information routinely exhibits excessive load times and database failures based on the enormous amount of queries, commands, and other tasks which must be executed for each set of data. The complexity of these operations further complicates maintaining such information. Therefore, a system that provides the capability to store a large volume of information while facilitating efficient retrieval and processing of such information is desired.

### SUMMARY

According to one aspect of the present disclosure, a computer-implemented method of managing stored genomic sequencing data is provided. In some embodiments, the computer-implemented method of managing stored genomic sequencing data comprises: detecting a trigger related to a call review event; accessing, based on the detected trigger, at least one portion of a denormalized data structure; transforming the at least one portion of the denormalized data structure into a normalized data structure in response to the accessing; receiving a first user request associated with the at least one portion of the denormalized data structure; accessing the normalized data structure in response to the first user request; and displaying, on a display screen, data contained within the normalized data structure.

In some embodiments, the method comprises: receiving a second user request associated with the displayed data; creating, based on the second user request, an entry in the denormalized data structure; transforming at least one second portion of the denormalized data structure, the at least one second portion including the entry; updating the normalized data structure based at least in part on the transforming of the at least one second portion; and displaying, on the display screen, data contained in the updated normalized data structure. In some embodiments, the second user request is related to a data modification operation including a call review override procedure. In some embodiments, the method comprises: receiving a second user request related to terminating call review; and associating the normalized data structure with a deletion operation in response to the second user request.

In some embodiments, the first user request is related to initiating a data review procedure. In some embodiments, the computer-implemented method includes identifying at least one normalized data structure associated with an idle time which exceeds a threshold; and removing the identified at least one normalized data structure from memory. In some embodiments, the normalized data structure is maintained based on a first schema, and the computer-implemented method further includes generating a second normalized data structure, wherein the second normalized data structure utilizes a second schema different from the first schema. In some embodiments, transforming includes using at least one JavaScript Object Notation B (JSONB) type operation. In some embodiments, transforming includes merging at least two database elements using a join query. In some embodiments, the denormalized data structure is maintained based on a first schema, and the normalized data structure is maintained based on a second schema different from the first schema. In some embodiments, generating the normalized data structure includes using an inheritance function based on at least one portion of denormalized data. In some embodiments, maintaining the denormalized data structure includes using a migration function. In some embodiments, updating the normalized data structure includes updating at least one row of data within the normalized data structure.

In some embodiments, a set of denormalized data includes one entry associated with one sequencing result, and a corresponding set of normalized data includes 1,000 entries associated with 1,000 variant calls for the one sequencing result. In some embodiments, the trigger related to a call review event is associated with at least one of: an assignment of a batch of samples, a creation of denormalized data, a second user request, or a batch loading operation. In some embodiments, the method comprises: detecting a trigger related to a sample reporting event; accessing, based on the detected trigger related to a sample reporting event, at least one set of information for facilitating sample reporting. In some embodiments, accessing at least one set of information for facilitating sample reporting further comprises: transforming at least one second portion of the denormalized data structure into a second normalized data structure; and generating at least one sample report based on the second normalized data structure.

In some embodiments, accessing at least one set of information for facilitating sample reporting further comprises: accessing at least one second portion of the denormalized data structure; and generating at least one sample report based on the at least one second portion of denormalized data structure. In some embodiments, accessing at least one set of information for facilitating sample reporting further comprises: accessing a plurality of normalized data structures; and generating at least one sample report based on a combination of data from the plurality of normalized data structures. In some embodiments, accessing at least one set of information for facilitating sample reporting further comprises: accessing a plurality of denormalized data structures; and generating at least one sample report based on a combination of data from the plurality of denormalized data structures.

In some embodiments, the present invention includes a non-transitory computer readable storage medium having instructions stored thereon, the instructions, when executed by one or more processors, cause the processors to perform operations comprising: detecting a trigger related to a call review event; accessing, based on the detected trigger, at least one portion of a denormalized data structure; transforming the at least one portion of the denormalized data structure into a normalized data structure in response to the accessing; receiving a first user request associated with the at least one portion of the denormalized data structure; accessing the normalized data structure in response to the first user request; and displaying, on a display screen, data contained within the normalized data structure.

In some embodiments, the present invention includes a system for analyzing a plurality of genomic samples, the system comprising: a display; one or more processors; and a memory storing one or more programs, wherein the one or more programs include instructions configured to be executed by the one or more processors, causing the one or more processors to perform operations comprising: detecting a trigger related to a call review event; accessing, based on the detected trigger, at least one portion of a denormalized data structure; transforming the at least one portion of the denormalized data structure into a normalized data structure in response to the accessing; receiving a first user request associated with the at least one portion of the denormalized data structure; accessing the normalized data structure in response to the first user request; and displaying, on a display screen, data contained within the normalized data structure.

### BRIEF DESCRIPTION OF THE DRAWINGS

FIG. 1 illustrates an exemplary process for managing stored genomic sequencing data.

FIG. 2A illustrates an exemplary representation of denormalized data maintained for managing stored genomic data in an analytic results management database.

FIG. 2B illustrates a first exemplary process for transforming denormalized data to normalized data in an analytic results management database.

FIG. 2C illustrates a second exemplary process for transforming denormalized data to normalized data in an analytic results management database.

FIG. 3A illustrates an exemplary user interface for a variant call level review utilizing an analytic results management database.

FIG. 3B illustrates an exemplary override function for use in variant call level review utilizing an analytic results management database.

FIG. 4 illustrates an exemplary process for optimizing normalized data.

FIG. 5 illustrates a general purpose computing system in which one or more systems of the present invention may be implemented.

### DETAILED DESCRIPTION

In general, the invention provides for an analytic results management database for managing information pertaining to a plurality of samples, and may be embodied as a system, method, or computer program product. Furthermore, the present invention may take the form of an entirely software embodiment, entirely hardware embodiment, or a combination of software and hardware embodiments. Even further, the present invention may take the form of a computer program product contained on a computer-readable storage medium, where computer-readable code is embodied on the storage medium. In another embodiment, the present invention may take the form of computer software implemented as a service (SaaS). Any appropriate storage medium may be utilized, such as optical storage, magnetic storage, hard disks, or CD-ROMs.

In the following description of the disclosure and examples, reference is made to the accompanying drawings in which it is shown by way of illustration specific examples that can be practiced. It is to be understood that other examples can be practiced and structural changes can be made without departing from the scope of the disclosure.

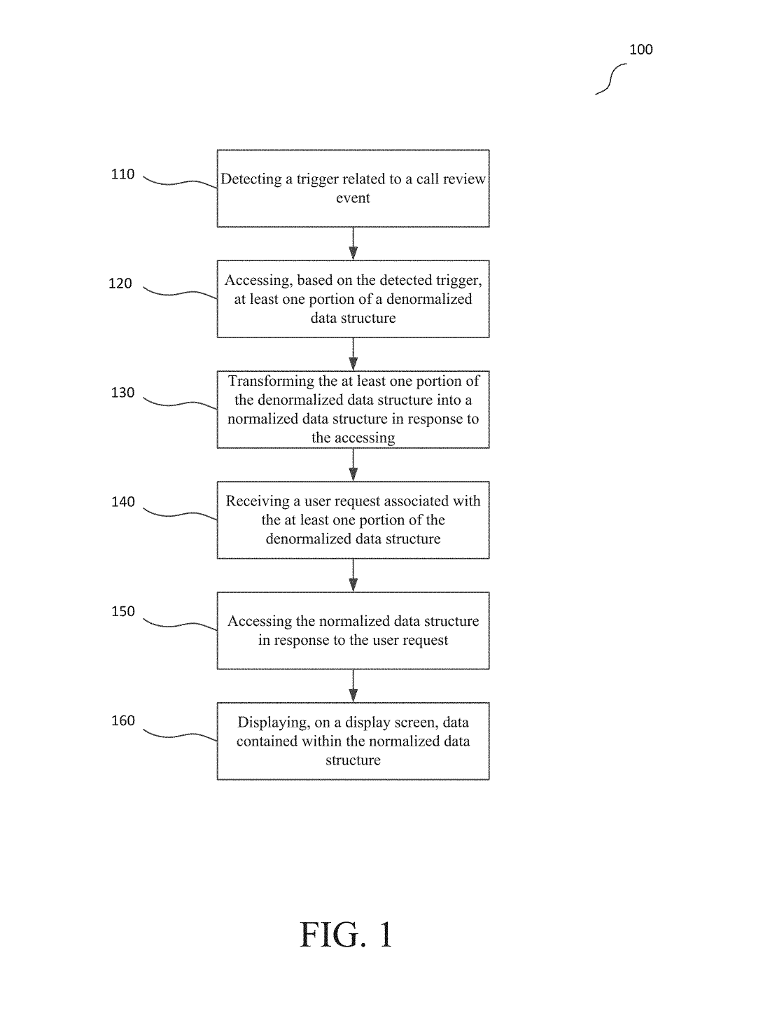

FIG. 1 illustrates an exemplary process 100 for managing stored genomic sequencing data. In one embodiment, process 100 may be configured, at least in part, as a database-driven web-facing application. In one embodiment, process 100 may be implemented utilizing Django framework and web application standards, as is known in the art. In some embodiments, process 100 may be further implemented by utilizing an object-relational database. For example, process 100 may implemented on one or more database servers utilizing PostgreSQL standards. Process 100 may further utilize, for example, one or more PostgreSQL database clusters, each including at least one database. Furthermore, for example, each database may include at least one named schema, where each named schema may further include at least one table. Process 100 may further utilize, for example, JavaScript Object Notation (JSON) data types or JSONB data types for storing and managing data. A JSONB data type may refer to the binary version of the JSON data type, which is stored in a decomposed binary format such that no reparsing of the data is required. A JSONB data type may further support indexing of data. A JSONB data type may be advantageous over a JSON data type in that a JSONB data type eliminates one or more data parsing operations, and thus results in increased efficiency for use in data processing. Those skilled in the art will appreciate that other configurations and standards may be utilized.

Process 100 may begin at step 110 by detecting a trigger related to a call review event. A call review event may be associated with the initiation of a review procedure, such as, for example, a variant call review procedure, a sample review procedure, or a sequencing batch preview procedure. Upon detecting the trigger at step 110, process 100 continues to step 120 by accessing, based on the detected trigger, at least one portion of a denormalized data structure. In general, a denormalized data structure may refer to a structure containing denormalized data, such that the data within the structure has been denormalized. In one embodiment, data utilized by the analytic results management database may be maintained at least in part as denormalized data and at least in part as normalized data. Furthermore, normalized data may be generated and removed from storage periodically as discussed herein. Normalized data may be maintained, for example, by utilizing one or more “inheritance” functions, whereas denormalized data may be maintained based on one or more “migrations” functions. Normalization of data may include the removal of data redundancies in order reduce or eliminate redundant data, and in turn, improve data integrity and reduce the required storage space for such data. Thus, a characteristic of normalized data is that such data includes little to no data redundancy. Denormalization of data may include the addition of redundant data to existing data in order to decrease the run time associated with accessing data via queries or other processes. A characteristic of denormalized data is that such data includes redundant data, and may thus allow for faster inserts of data due to less overhead required and smaller index sizes associated with the data. However, data denormalization may reduce system performance where there is a high volume of data and tasks such as data inserts, modifications, and deletions are routinely required. Therefore, based on the large amount of sequencing data generated prior to variant call review, temporarily normalizing select portions of such data, as described herein, may provide the advantage of facilitating efficient data modification tasks while still providing the capability to maintain a vast amount of data.

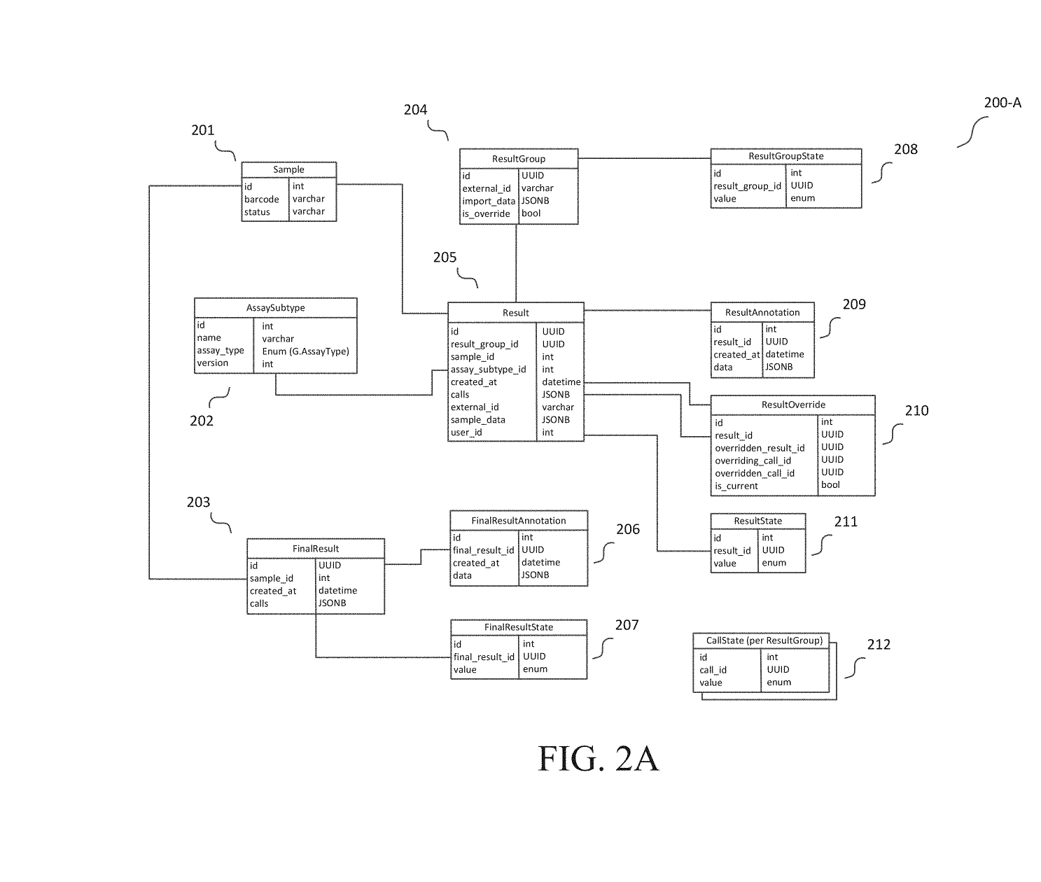

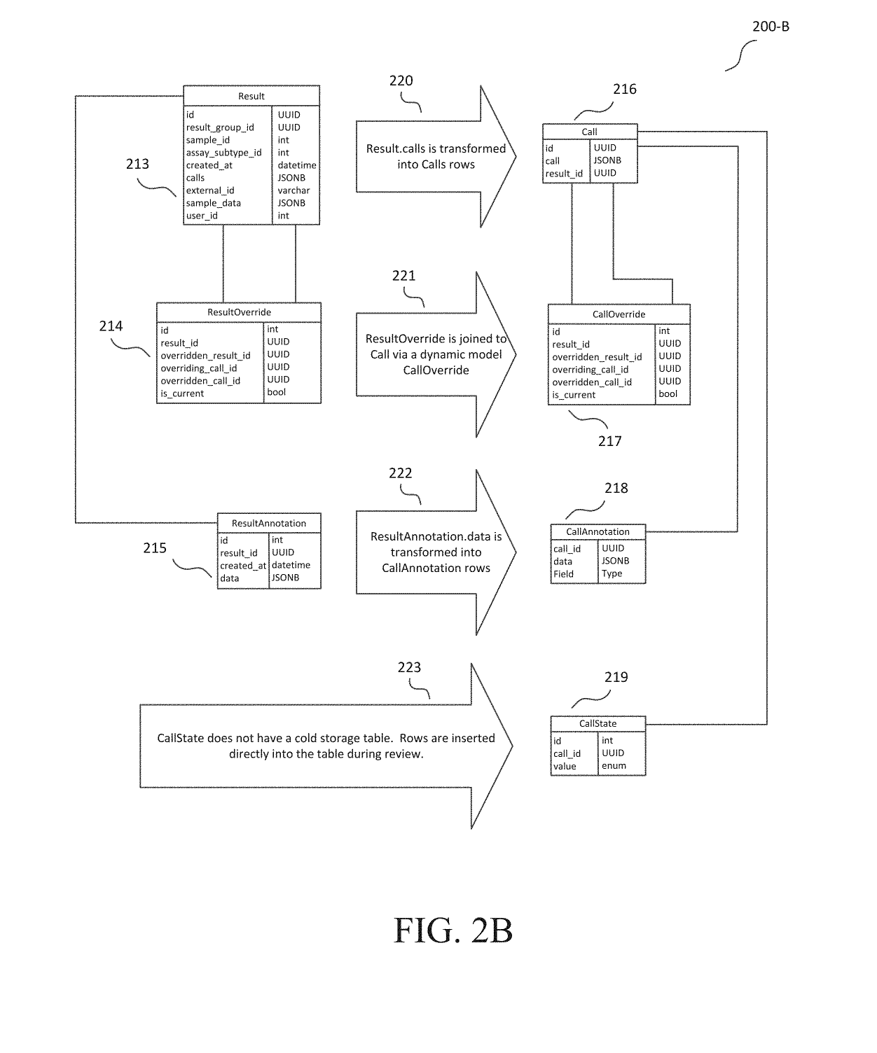

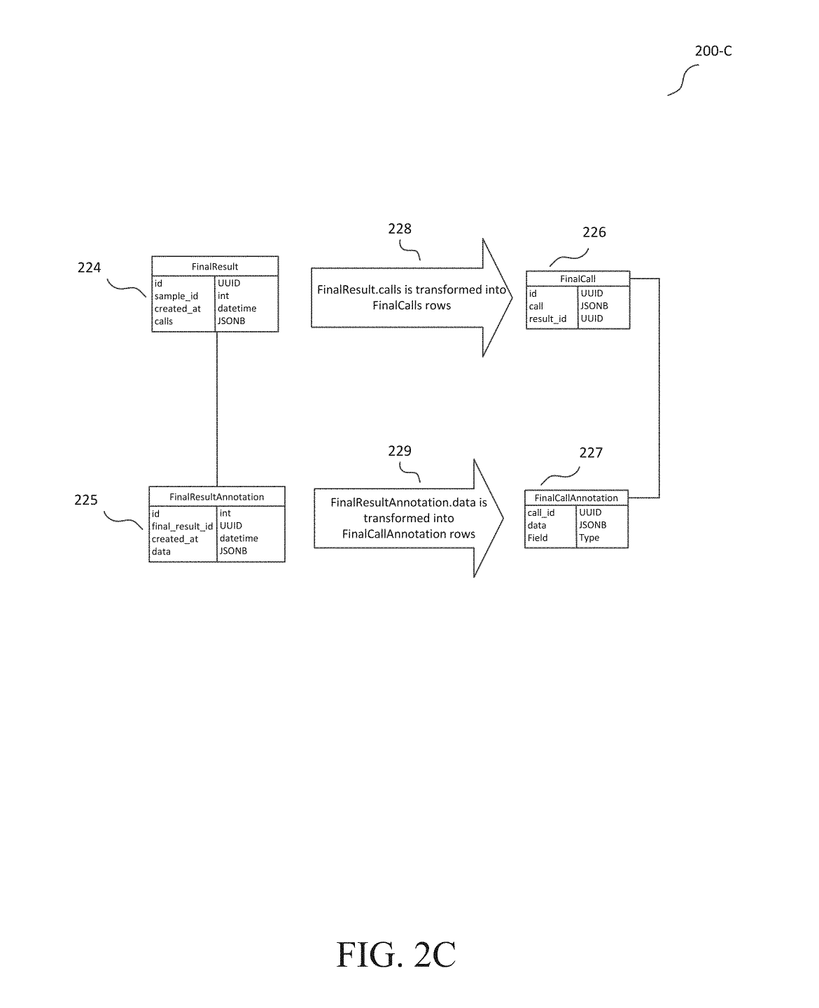

FIG. 2A illustrates an exemplary representation 200-A of denormalized data maintained for managing stored genomic data in an analytic results management database. In one embodiment, denormalized data may include at least one of a Sample Object 201, an AssaySubtype Object 202, a FinalResult Object 203, a ResultGroup Object 204, a Result Object 205, a FinalResultAnnotation Object 206, a FinalResultState Object 207, a ResultGroupState Object 208, a ResultAnnotation Object 209, a ResultOverride Object 210, a ResultState Object 211, and a CallState Object 212.

For example, a Sample Object 201 may include at least one of: an identification (ID) field as an integer value, a barcode field as a variable character field type, and a status field as a variable character field type. Furthermore, an AssaySubtype Object 202 may include at least one of: an ID field as an integer type, a name field as a variable character field type, an assay_type field as an enumerated type, and a version field as an integer type. Furthermore, a FinalResult Object 203 may include at least one of: an ID field as a universally unique identifier (UUID) type, a sample ID field as an integer type, a creation field as a timestamp type, and a calls field as a JSONB type. Furthermore, a ResultGroup Object 204 may include at least one of: an ID field as a UUID type, an external ID field as a variable character field type, an import data field as a JSONB type, and an “is override” field as a boolean type. Furthermore, a Result Object 205 may include at least one of: an ID field as a UUID type, a result group ID field as a UUID type, a sample ID field as a integer type, an assay subtype ID field as an integer type, a creation field as a timestamp type, a calls field as a JSONB type, an external ID as a variable character field type, a sample data field as a JSONB type, and a user ID as an integer type. Furthermore, a FinalResultAnnotation Object 206 may include at least one of: an ID as an integer type, a final result ID as a UUID type, a creation field as a timestamp type, and a data field as a JSONB type.

Furthermore, a FinalResultState Object 207 may include at least one of: an ID field as an integer type, a final result ID field as a UUID type, and a value field as an enumerated type. Furthermore, a ResultGroupState Object 208 may include at least one of: an ID field as an integer type, a result group ID field as a UUID type, and a value field as an enumerated type. Furthermore, a ResultAnnotation Object 209 may include at least one of: an ID field as an integer type, a result ID field as a UUID type, a creation field as a timestamp type, and a data field as a JSONB type. Furthermore, a ResultOverride Object 210 may include at least one of: an ID field as an integer type, a result ID field as a UUID type, an overridden result ID field as a UUID type, an overriding call ID field as a UUID type, an overridden call ID field as a UUID type, and an “is current” field as a boolean type. Furthermore, a ResultState Object 211 may include at least one of: an ID field as an integer type, a result ID field as a UUID type, and a value field as an enumerated type. Furthermore, a CallState Object 212 may include at least one of: an ID field as an integer type, a call ID field as a UUID type, and a value field as an enumerated type.

Referring back to FIG. 1, process 100 may continue, in response to accessing at least one portion of a denormalized data structure, to step 130 by transforming the at least one portion of the denormalized data structure into a normalized data structure. FIG. 2B illustrates an exemplary process 200-B for transforming denormalized data to normalized data in an analytic results management database. In one embodiment, process 200-B may include a Result Object 213, a ResultOverride Object 214, and a ResultAnnotation Object 215, and each of Result Object 213, ResultOverride Object 214, and ResultAnnotation Object 215 may be stored as denormalized data. In some embodiments, Result Object 213, ResultOverride Object 214, and ResultAnnotation Object 215 each correspond to Result Object 205, ResultOverride Object 210, and ResultAnnotation Object 209 of FIG. 2A, respectively. Process 200-B may further include a Call Object 216, a CallOverride Object 217, a CallAnnotation Object 218, and a CallState Object 219, and each of Call Object 216, CallOverride Object 217, CallAnnotation Object 218, and CallState Object 219 may be maintained as normalized data.

In some embodiments, Result Object 213 may include at least one of: an identification field as a UUID type, a result group identification (ID) field as a UUID type, a sample ID field as a integer type, an assay subtype ID field as an integer type, a creation field as a timestamp type, a calls field as a JSONB type, an external ID as a variable character field type, a sample data field as a JSONB type, and a user ID as an integer type. Furthermore, ResultOverride Object 214 may include at least one of: an ID field as an integer type, a result ID field as a UUID type, an overridden result ID field as a UUID type, an overriding call ID field as a UUID type, an overridden call ID field as a UUID type, and an “is current” field as a boolean type. Furthermore, ResultAnnotation Object 215 may include at least one of: an ID field as an integer type, a result ID field as a UUID type, a creation field as a timestamp type, and a data field as a JSONB type.

In one embodiment, denormalized data may be transformed to normalized data by one or more transformation steps. For example, at least a portion of Result Object 213 may be transformed into at least a part of Call Object 216 by transformation process 220. In one example, transformation process 220 may transform the “calls” field (a JSONB type) of Result Object 213 into one or more call rows of data, resulting in the creation of normalized data including at least a part of Call Object 216. As another example, ResultOverride Object 214 may be transformed by transformation process 221. In one example, transformation process 221 may transform ResultOverride Object 214 based on a “join” operation. In one embodiment, the “join” operation is a “join query” corresponding to a JSONB function. The “join query” may be utilized such that ResultOverride Object 214 is joined, using the join query, to Call Object 216 via CallOverride Object 217. In one example, CallOverride Object 217 may be utilized as a dynamic model. As another example, at least a portion of ResultAnnotation Object 215 may be transformed into CallAnnotation Object 218 by transformation process 222. In one example, transformation process 222 may transform the “data” field (a JSONB type) of ResultAnnotation Object 215 into one or more call annotation rows of data, resulting the creation of normalized data including CallAnnotation Object 218. As another example, CallState Object 219 may be created as normalized data by direct insertion of rows into CallState Object 219 during call review, such that CallState Object 219 has no corresponding denormalized data for transformation.

Denormalized data may include one or more data fields for retrieval during variant call review. For example, Call Object 216 may include at least one of: an ID field as a UUID type, a call field as a JSONB type, and a result ID field as a UUID type. In one embodiment, Call Object 216 includes one or more instances of call data arranged in rows, where each row includes an ID field as a UUID type, a call field as a JSONB type, and a result ID field as a UUID type. Furthermore, CallOverride Object 217 may include at least one of: an ID field as an integer type, a result ID field as a UUID type, an overridden result ID field as a UUID type, an overriding call ID field as a UUID type, an overridden call ID field as a UUID type, and an “is current” field as a boolean type. Furthermore, a CallAnnotation Object 218 may include at least one of: a call ID field of a UUID type, and a data field as a JSONB type. Furthermore, CallState Object 219 may include at least one of: an ID field as an integer type, a call ID field as a UUID type, and a value field as an enumerated type.

FIG. 2C illustrates another exemplary process 200-C for transforming denormalized data to normalized data in an analytic results management database. In one embodiment, process 200-C may include a FinalResult Object 224 and a FinalResultAnnotation Object 225, which may each be stored as denormalized data. In some embodiments, FinalResult Object 224 and FinalResultAnnotation Object 225 correspond to FinalResult Object 203 and FinalResultAnnotation Object 206 of FIG. 2A, respectively. Process 200-C may further include a FinalCall Object 226 and a FinalCallAnnotation Object 227, which may be maintained as normalized data.

Furthermore, denormalized data may be transformed to normalized data by one or more transformation steps. For example, at least a portion of FinalResult Object 224 may be transformed into FinalCall Object 226 by transformation process 228. In one example, transformation process 228 may transform the “calls” field (a JSONB type) of FinalResult Object 224 into one or more final call rows of data, resulting in the creation of normalized data including FinalCall Object 226. As another example, at least a portion of FinalResultAnnotation Object 225 may be transformed into FinalCallAnnotation Object 227 by transformation process 229. In one example, transformation process 229 may transform the “data” field (a JSONB type) of FinalResultAnnotation Object 225 into one or more final call annotation rows of data, resulting in the creation of normalized data including FinalCallAnnotation Object 227.

The creation of normalized data is now further described. In one embodiment, denormalized data with JSONB type fields are utilized to create normalized data, wherein the normalized data is further processed during call review. In some embodiments, normalization may result in the creation of a plurality of sets of normalized data, such as a plurality of normalized tables. In one embodiment, one or more normalized tables are maintained in one or more distinct schemas, such that the at least one or more normalized tables are maintained separately among the one or more schemas. Furthermore, a query planner may be configured to resolve tables based on utilization of a “search path” list. For example, a “search path” list may contain a list of schemas, and may be altered at query time in order to select a scheme containing specific normalized tables. In one embodiment, a “search path” list may be altered to select a schema containing normalized tables corresponding to a specific result group by utilizing, for example, ResultGroupObject 204 in FIG. 2A. In one embodiment, the ResultGroupObject 204 may be utilized to generate normalized data such that the normalized data has a table size limit proportional to the number of calls in a given sample assay. Such a process may be advantageous in removing table constraints, for example, in situations where a given database system refrains from cross referencing for schemas, such as, e.g., PostgreSQL.

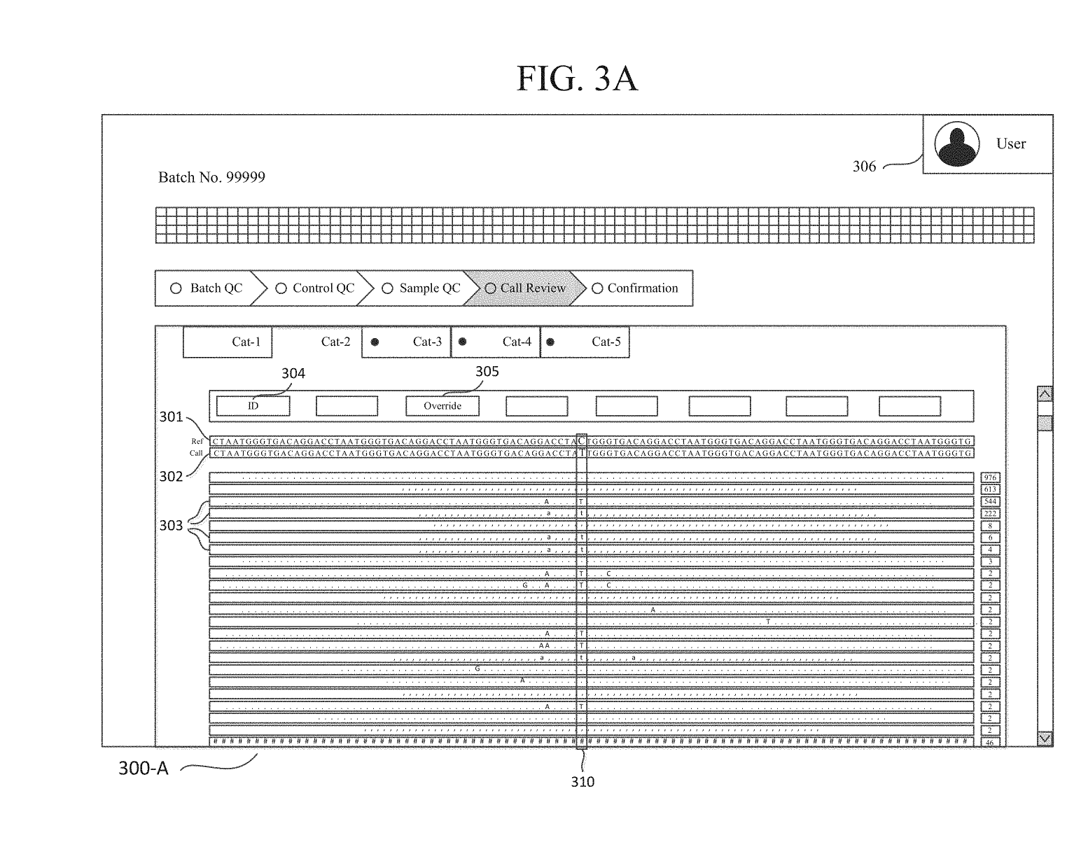

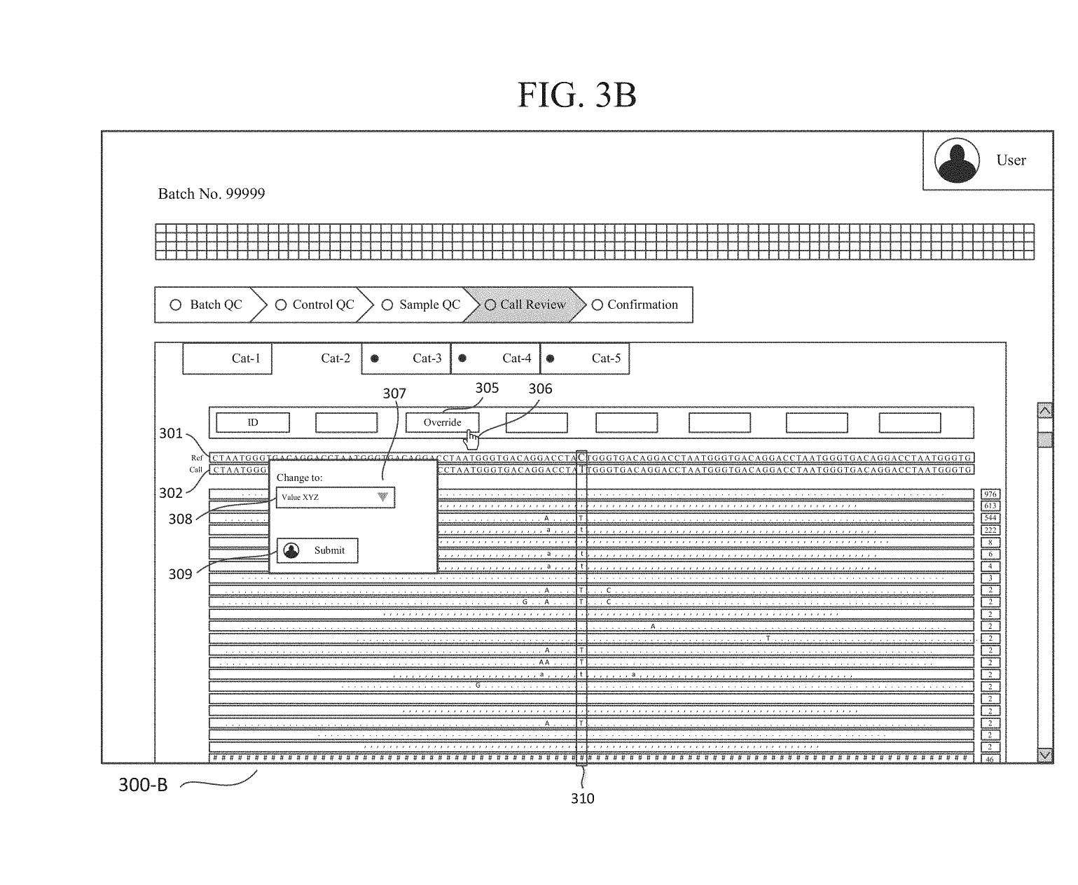

Referring back to FIG. 1, process 100 may continue, after transforming at least one portion of the denormalized data structure into a normalized data structure, to step 140 by receiving a user request associated with the at least one portion of the denormalized data structure. Furthermore, at step 150, the normalized data structure is accessed in response to the user request, and data contained within the normalized data structure is displayed on a display screen at step 160. FIGS. 3A and 3B illustrate exemplary user interfaces (UI) 300-A and 300-B in which the process for managing stored genomic sequencing data may be utilized, and further, in which such data may be displayed to allow for user review and manipulation of the data. In one embodiment, user interface 300-A is utilized as a call review interface in order to review a plurality of genomic samples. UI 300-A may further permit a user to view organized information relating to one or more variant calls. For example, UI 300-A may include reference sequence information 301, which may refer to a reference sequence to which a current sample is being tested against. UI 300-A may further include, for example, a called variant 302, which may be tested against reference sequence information 301. In one example, reference sequence information and called variant information may be represented as “C,” “T,” “A,” and/or “G,” which may refer to the nucleotides of cytosine, thymine, adenine, and guanine, respectively. Furthermore, information within a UI may include information indicative of the absence of sequencing information, in order to represent an insertion or deletion.

Furthermore, UI 300-A may include additional rows of individual sequence reads 303. Individual sequence reads 303 may include information pertaining to sequence reads for the sample associated with a specific sample. In one embodiment, indicator 304 corresponds to a sample identifier which identifies a current sample. For example, sample data utilized for call review may be denormalized data as described herein, such that the data is efficiently accessed and manipulated by the user. UI 300-A may further be tailored for use by a specific user, such as a user depicted by a user indicator 306. Furthermore, UI 300-A may include an override function 305. In one example, during evaluation of the call review data depicted on UI 300-A, a user may activate override function 305 in order to modify the call review data depicted within UI 300-A. Furthermore, a user may highlight a given column 310 and activate override function 305, which may cause a notification window to appear on a display and permit a user to override call review data. The override function is described in more detail in FIG. 3B. Override function 305 may be configured to become deactivated once the user performs an override function as described herein. For example, after the override function has been performed, the override function 305 may change appearance to indicate an “inactive” state (e.g., override function 305 may transform to a gray color), and may become unresponsive to user interaction.

After displaying the information related to the normalized data structure, a second user request related to the displayed information may be received. In one embodiment, the request related to the displayed information involves utilization of an override function. Referring now to FIG. 3B, a UI 300-B is depicted showing a UI after activation of override function 305. For example, a user may utilize cursor 306 by moving cursor 306 over override function 305 and further making a selection operation such as single-click or double-click to activate override function 305. Upon activation of override function 305, notification window 307 may appear on the display. In one embodiment, notification window 307 may include a drop-down menu 308 having one or more values to change a current called variant value 302 associated with a highlighted column 310. In one embodiment, a user may activate drop-down menu 308 (e.g., by a single-click, double-click, or similar method) in order to select a new value for a highlighted called variant value 302 by selecting the new value from drop-down menu 308, and further clicking submit button 309. In one embodiment, submit button 309 includes an icon representing the user currently logged into the system. Upon activating submit button 309, the system may store the value selected by the user from drop-down menu 308, and may update the stored genomic data, as described herein.

After receiving a second user request related to the displayed information, an entry in a denormalized data structure may be created based on the second request. In one embodiment, the process of updating stored genomic data utilizing the override feature may invoke at least one normalization process as discussed with respect to FIGS. 2B-2C. For example, referring back to FIG. 2B, when a user utilizes the override feature, ResultOverride Object 214 may be accessed such that one or more fields in ResultOverride Object 214 are updated. In one embodiment, updating includes making a new entry within denormalized data, such that denormalized data includes previous versions of data (e.g., previous call information) and a current version of data (e.g., recently entered data from a user via override function). For example, where a user utilizes an override feature to change an existing called variant value (e.g., a nucleotide corresponding to “C”) to a new called variant value (e.g., a nucleotide corresponding to “T”), each of the overriding call ID field and the overridden call ID field may be accessed. In one embodiment an existing overriding call ID field and an existing overridden call ID field may be preserved in the denormalized data. Furthermore, a new overriding call ID field and a new overridden call ID field may be added to the denormalized data. New overridden call ID field may correspond, for example, to a value selected to be replaced by the user within UI 300-A as discussed with respect to FIG. 3A. New overriding call ID field may correspond, for example, to a new value selected by the user menu 308 as discussed with respect to the override feature discussed with respect to FIG. 3B.

Furthermore, existing ResultOverride Object 214 may be preserved in the denormalized data, while a new ResultOverride Object 214 is added to the normalized data with updated values for new overriding call ID field and a new overridden call ID field, for example. In another example, existing overriding call ID field and existing overridden call ID field are preserved within ResultOverride Object 214, and new overriding call ID field and new overridden call ID field are added to ResultOverride Object 214.

After creating an entry in the denormalized data structure, the at least one second portion of the denormalized data structure may be transformed, where the at least one second portion includes the entry. For example, in FIG. 2B, upon updating the denormalized data with one or more new fields based on the user invoking the override function, normalized data may further be updated based on one or more transformation processes. For example, once denormalized data is updated, a transformation process such as transformation processes 220-222 in FIG. 2B may be utilized. In one example, after updating ResultOverride Object 214, transformation process 221 may transform ResultOverride Object 214 based on a “join” operation as discussed above. In one embodiment, the “join” operation is a “join query” corresponding to a JSONB function. The “join query” may be utilized such that ResultOverride Object 214 is joined, using the join query, to Call Object 216 via CallOverride Object 217.

Furthermore, after transforming at least one second portion of the denormalized data structure, the normalized data structure may be updated based at least in part on the transforming of the at least one second portion. Upon utilization of transformation process 221 in FIG. 2B, normalized data including CallOverride Object 217 may be updated based on the override function invoked by the user. For example, CallOverride Object 217 may now contain updated new fields such as a new overriding call ID field and a new overridden call ID field based on the user action.

Furthermore, the call review processes depicted in FIGS. 3A-3B may be optimized by utilization of normalized data without reference to denormalized data during certain stages of call review. For example, based on the storage scheme involving both normalized and denormalized data, specific call review processes may only be required to access normalized data for retrieving, sorting, modifying, or otherwise manipulating data within a call review session. Such a process, therefore, may be advantageous based on the limited amount of data storage required, and the system resources required to access and process such data based on the various tasks involved in call review. For example, for a given call review function, the required storage of the normalized data may be a small fraction of the size required for invoking the same function on denormalized data, and thus, the system resources required to access and process the normalized data is a small fraction of the resources otherwise required where only the denormalized data is utilized.

Optimization of normalized data structures is also advantageous over conventional systems in that optimization of the normalized data is applied on a per use case basis, and thus, does not affect other separate normalized data or denormalized data. Furthermore, utilization of normalized data may allow for the implementation of application specific and customized data for use with normalized data structures, since the denormalized data, while applicable to a broader set of objects, may be constrained in flexibility and customization otherwise. While denormalized data may be advantageous for the purpose of storing compressed versions of the normalized data, normalized data structures provide the option for more efficient querying, filtering, sorting, indexing, and adding of additional data from internal and external sources.

In one example, a set of denormalized data may include a specific number of data entries per sequencing result, whereas a set of normalized data corresponding to the normalized form of the set of denormalized data may include a proportional number of data entries per the sequencing result. For example, a given set of denormalized data may include one data entry per one sequencing result, whereas a set of normalized data, corresponding to the normalized form of the given set of denormalized data, may include a 1,000 data entries corresponding to 1,000 variant calls for the one sequencing result. Arranging data such that normalized data includes a many variant calls per one sequencing result within denormalized data may be advantageous in that such an arrangement increases the efficiency in processing relevant data. For example, such arrangement may result in an increased height of a given data structure (e.g., adding rows to the data structure), while reducing the width of a given structure (e.g., reducing columns of the data structure), such that processing such a data structure involves performing less operations based on the resultant height and width.

Even further, the invocation of normalization process is not limited to a user override feature discussed herein, and may be based on other features pertaining to modifying call review data. Even further, the normalization process may be invoked by other processes or methods where stored data must be updated and preserved accordingly. Although the processes described herein may reference transformation of specific data fields and corresponding data types from denormalized data to normalized data, such transformation as described herein is not specific data fields and types.

Similar transformation processes may be utilized in sample reporting. For example, sample reporting may be triggered by certain events such as automatic, routine report schedules (e.g., a daily or weekly report), or may be triggered manually by an administrator or other user. Reports may further be triggered, for example, based on a patient request or new patient test order. Upon detecting a sample reporting event, information may be accessed which is relevant to generating any requested sample reports. In one example, a denormalized data structure is accessed, and further transformed into a normalized data structure having information pertinent to a specific report to be generated. Such normalized data structures may be re-used for further report generation in order to reduce the need to access and transform denormalized data. A sample report may then be generated based on the normalized data. Furthermore, sample reports may be generated directly from denormalized data, such that the denormalized data is not transformed between the trigger and report generation. Even further, sample reports may be generated based on information obtained from a combination of denormalized data and/or normalized data. In one example, sample reports may be generated based on a combination of data obtained from a plurality of denormalized data. In another example, sample reports may be generated based on a combination of data obtained from a plurality of normalized data. In yet another example, data obtained for sample reporting may be accessed through an application programming interface.

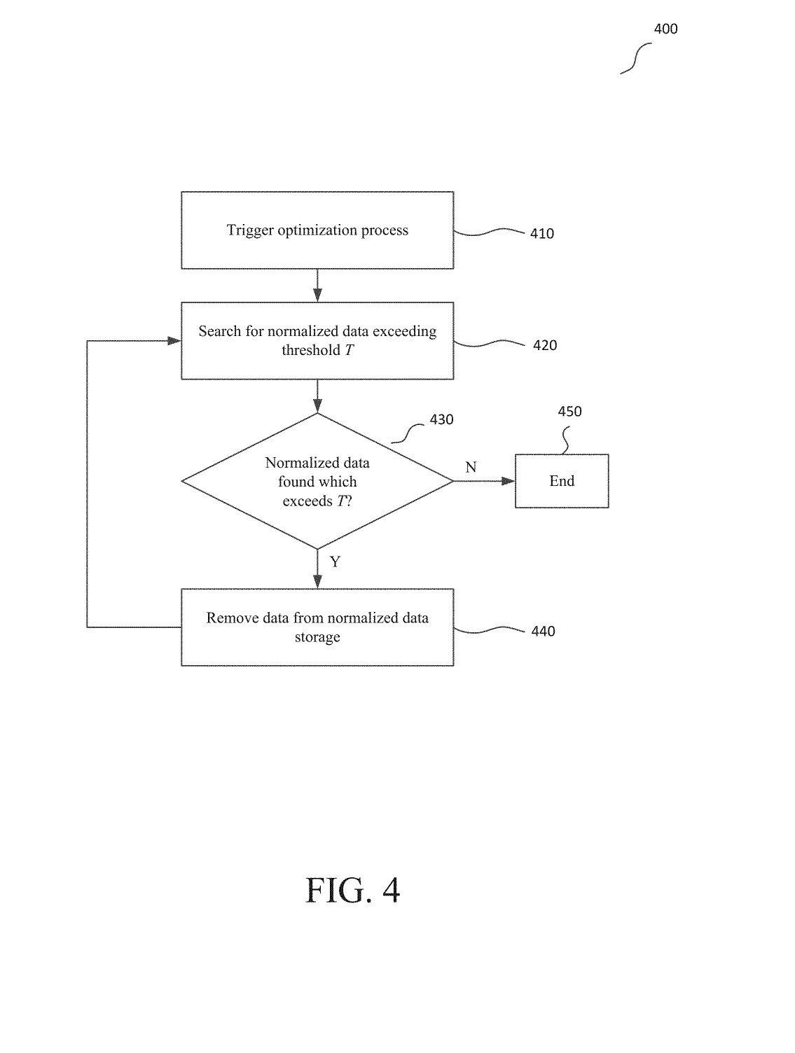

FIG. 4 illustrates an exemplary process 400 for optimizing normalized data. In one embodiment, process 400 begins based on one or more triggers to optimize normalized data. For example, one or more triggers may be based upon a timestamp, a user action, a storage limit, or other factors as will be appreciated by one of skill in the art. For example, process 400 may be based upon a daily, weekly, or monthly trigger, and/or may further be based on a preconfigured user setting. In another example, a system administrator may invoke process 400 in order to optimize normalized data. As another example, a percentage of system resources may be dedicated to normalized data, such that when normalized data exceeds a specific threshold of storage allowed by the system, process 400 is triggered. For example, once normalized data exceeds 90% of the total amount of storage dedicated to normalized data, process 400 may be initiated at step 410.

After triggering of normalization process at step 410, process 400 then searches for normalized data exceeding a specific threshold T at step 420. For example, threshold T may represent a value of time set by an administrator or other user, such that any normalized data that has not been utilized for a time greater than threshold T is identified. In one example, each set of normalized data may be associated with a value t which indicates a last access time of the normalized data. Whenever normalized data is accessed, the value t associated with such data is reset to a time associated with the access time. Thus, where normalized data has not been accessed within, for example, 10 days, value t will be equal to a time approximately 10 days prior to a current time, and may indicate that normalized data has been idle for approximately 10 days. At step 420, process 400 searches for any normalized data having a value t resulting in an idle time of greater than threshold T. For example, where a user preconfigures threshold T to equal a time of 5 days, the normalized data having an idle time of 10 days will be identified at step 430 as data which exceeds threshold T.

At step 430, process 400 identifies normalized data having a value t associated with a time exceeding threshold T, and process 400 may further proceed to remove the identified normalized data from storage at step 440. For example, where the normalized data having value t associated with 10 days of idle time exceeds a preset threshold T of 5 days, the normalized data having value t associated with 10 days of idle time is removed from storage. In one example, step 440 results in normalized data being flagged from removal from storage, where actual deletion of the normalized data from storage occurs at a future date. For example, normalized data which is flagged for removal may remain in storage for a preset time until a mass deletion event occurs. In one embodiment, the removal time associated with flagged data is the sooner of 14 days or the mass deletion event.

After removal of the identified normalized data having a value t associated with a time exceeding threshold T at step 440, process 400 may return to step 420 to search for any normalized data having a value t resulting in an idle time of greater than threshold T. Where process 400 searches for normalized data exceeding threshold T, but does not locate normalized data exceeding threshold T, process 400 may end at step 450. One of skill in the art will appreciate that process 400 may also be configured to be terminated by other events, such as an application having higher priority, user termination, etc.

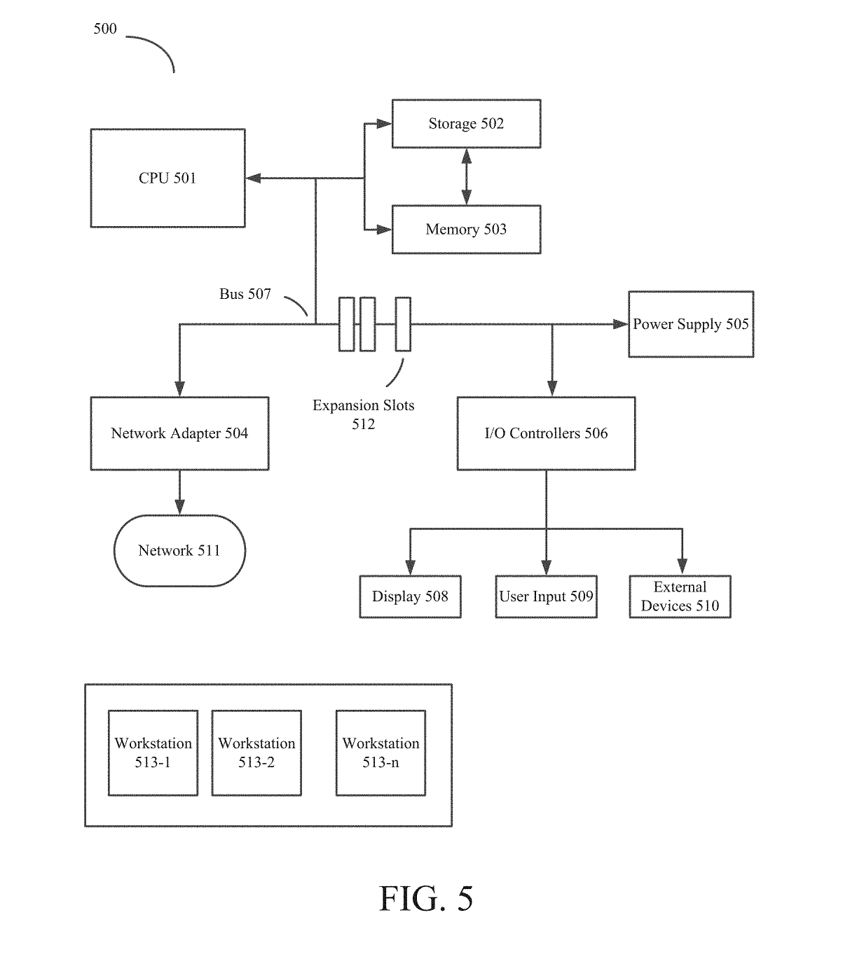

FIG. 5 illustrates a general purpose computing system 500 in which one or more systems, as described herein, may be implemented. System 500 may include, but is not limited to known components such as central processing unit (CPU) 501, storage 502, memory 503, network adapter 504, power supply 505, input/output (I/O) controllers 506, electrical bus 507, one or more displays 508, one or more user input devices 509, and other external devices 510. It will be understood by those skilled in the art that system 500 may contain other well-known components which may be added, for example, via expansion slots 512, or by any other method known to those skilled in the art. Such components may include, but are not limited, to hardware redundancy components (e.g., dual power supplies or data backup units), cooling components (e.g., fans or water-based cooling systems), additional memory and processing hardware, and the like.

System 500 may be, for example, in the form of a client-server computer capable of connecting to and/or facilitating the operation of a plurality of workstations or similar computer systems over a network. In another embodiment, system 500 may connect to one or more workstations over an intranet or internet network, and thus facilitate communication with a larger number of workstations or similar computer systems. Even further, system 500 may include, for example, a main workstation or main general purpose computer to permit a user to interact directly with a central server. Alternatively, the user may interact with system 500 via one or more remote or local workstations 513. As will be appreciated by one of ordinary skill in the art, there may be any practical number of remote workstations for communicating with system 500.

CPU 501 may include one or more processors, for example Intel® Core™ i7 processors, AMD FX™ Series processors, or other processors as will be understood by those skilled in the art. CPU 501 may further communicate with an operating system, such as Windows NT® operating system by Microsoft Corporation, Linux operating system, or a Unix-like operating system. However, one of ordinary skill in the art will appreciate that similar operating systems may also be utilized. Storage 502 may include one or more types of storage, as is known to one of ordinary skill in the art, such as a hard disk drive (HDD), solid state drive (SSD), hybrid drives, and the like. In one example, storage 502 is utilized to persistently retain data for long-term storage. Memory 503 may include one or more types of memory as is known to one of ordinary skill in the art, such as random access memory (RAM), read-only memory (ROM), hard disk or tape, optical memory, or removable hard disk drive. Memory 503 may be utilized for short-term memory access, such as, for example, loading software applications or handling temporary system processes.

As will be appreciated by one of ordinary skill in the art, storage 502 and/or memory 503 may store one or more computer software programs. Such computer software programs may include logic, code, and/or other instructions to enable processor 501 to perform the tasks, operations, and other functions as described herein, and additional tasks and functions as would be appreciated by one of ordinary skill in the art. Operating system 502 may further function in cooperation with firmware, as is well known in the art, to enable processor 501 to coordinate and execute various functions and computer software programs as described herein. Such firmware may reside within storage 502 and/or memory 503.

Moreover, I/O controllers 506 may include one or more devices for receiving, transmitting, processing, and/or interpreting information from an external source, as is known by one of ordinary skill in the art. In one embodiment, I/O controllers 506 may include functionality to facilitate connection to one or more user devices 509, such as one or more keyboards, mice, microphones, trackpads, touchpads, or the like. For example, I/O controllers 506 may include a serial bus controller, universal serial bus (USB) controller, FireWire controller, and the like, for connection to any appropriate user device. I/O controllers 506 may also permit communication with one or more wireless devices via technology such as, for example, near-field communication (NFC) or Bluetooth™. In one embodiment, I/O controllers 506 may include circuitry or other functionality for connection to other external devices 510 such as modem cards, network interface cards, sound cards, printing devices, external display devices, or the like. Furthermore, I/O controllers 506 may include controllers for a variety of display devices 508 known to those of ordinary skill in the art. Such display devices may convey information visually to a user or users in the form of pixels, and such pixels may be logically arranged on a display device in order to permit a user to perceive information rendered on the display device. Such display devices may be in the form of a touch-screen device, traditional non-touch screen display device, or any other form of display device as will be appreciated be one of ordinary skill in the art.

Furthermore, CPU 501 may further communicate with I/O controllers 506 for rendering a graphical user interface (GUI) on, for example, one or more display devices 508. In one example, CPU 501 may access storage 502 and/or memory 503 to execute one or more software programs and/or components to allow a user to interact with the system as described herein. In one embodiment, a GUI as described herein includes one or more icons or other graphical elements with which a user may interact and perform various functions. For example, GUI 507 may be displayed on a touch screen display device 508, whereby the user interacts with the GUI via the touch screen by physically contacting the screen with, for example, the user's fingers. As another example, GUI may be displayed on a traditional non-touch display, whereby the user interacts with the GUI via keyboard, mouse, and other conventional I/O components 509. GUI may reside in storage 502 and/or memory 503, at least in part as a set of software instructions, as will be appreciated by one of ordinary skill in the art. Moreover, the GUI is not limited to the methods of interaction as described above, as one of ordinary skill in the art may appreciate any variety of means for interacting with a GUI, such as voice-based or other disability-based methods of interaction with a computing system.

Moreover, network adapter 504 may permit device 500 to communicate with network 511. Network adapter 504 may be a network interface controller, such as a network adapter, network interface card, LAN adapter, or the like. As will be appreciated by one of ordinary skill in the art, network adapter 504 may permit communication with one or more networks 511, such as, for example, a local area network (LAN), metropolitan area network (MAN), wide area network (WAN), cloud network (IAN), or the Internet.

One or more workstations 513 may include, for example, known components such as a CPU, storage, memory, network adapter, power supply, I/O controllers, electrical bus, one or more displays, one or more user input devices, and other external devices. Such components may be the same, similar, or comparable to those described with respect to system 500 above. It will be understood by those skilled in the art that one or more workstations 513 may contain other well-known components, including but not limited to hardware redundancy components, cooling components, additional memory/processing hardware, and the like.

As used herein, the terminology as used throughout the description of the invention is for the purpose of describing particular embodiments only. Such terminology does not limit the scope of the invention in any way. For example, singular forms of “a,” “an” and “the” are intended to include plural forms unless indicated otherwise. Furthermore, terms such as “comprises” or “comprising” specify the presence of indicated features, components, steps, etc., but do not preclude the presence or addition of one or more other features, components, steps, etc. The description may also include the term “in,” which may include “in” and “on” unless clearly indicated otherwise. Furthermore, usage of the term “or” includes both conjunctive and disjunctive meanings, unless clearly indicated otherwise. That is, unless expressly stated otherwise, the term “or” may include “and/or.”

It will be further understood that various modifications to the invention may be made by one skilled in the art without departing from the spirit and scope of the invention as defined in the claims. For example, numerous changes, substitutions, and variations with respect to the systems and methods as described may occur. One of ordinary skill in the art will understand that various alternative embodiments may be employed to practice the invention, and that any feature may be combined with any other feature, whether such features are preferred or not.

What is claimed is:

1. A computer-implemented method of managing stored genomic sequencing data, the method comprising:
detecting a trigger related to a call review event;
accessing, based on the detected trigger, at least one portion of a denormalized data structure;
transforming the at least one portion of the denormalized data structure into a normalized data structure in response to the accessing;
receiving a first user request associated with the at least one portion of the denormalized data structure;
accessing the normalized data structure in response to the first user request; and
displaying, on a display screen, data contained within the normalized data structure.

2. The method of claim 1, further comprising:
receiving a second user request associated with the displayed data;
creating, based on the second user request, an entry in the denormalized data structure;
transforming at least one second portion of the denormalized data structure, the at least one second portion including the entry;
updating the normalized data structure based at least in part on the transforming of the at least one second portion; and
displaying, on the display screen, data contained in the updated normalized data structure.

3. The method of claim 2, wherein the second user request is related to a data modification operation including a call review override procedure.

4. The method of claim 1, further comprising:
receiving a second user request related to terminating call review; and
associating the normalized data structure with a deletion operation in response to the second user request.

5. The method of claim 1, wherein the first user request is related to initiating a data review procedure.

6. The method of claim 1, further comprising:
identifying at least one normalized data structure associated with an idle time which exceeds a threshold; and
removing the identified at least one normalized data structure from memory.

7. The method of claim 1, wherein the normalized data structure is maintained based on a first schema, the method further comprising:
generating a second normalized data structure, wherein the second normalized data structure utilizes a second schema different from the first schema.

8. The method of claim 1, wherein transforming includes using at least one JavaScript Object Notation B (JSONB) type operation.

9. The method of claim 1, wherein transforming includes merging at least two database elements using a join query.

10. The method of claim 1, wherein the denormalized data structure is maintained based on a first schema, and the normalized data structure is maintained based on a second schema different from the first schema.

11. The method of claim 1, wherein generating the normalized data structure includes using an inheritance function based on at least one portion of denormalized data.

12. The method of claim 1, wherein maintaining the denormalized data structure includes using a migration function.

13. The method of claim 1, wherein updating the normalized data structure includes updating at least one row of data within the normalized data structure.

14. The method of claim 1, wherein a set of denormalized data includes one entry associated with one sequencing result, and a corresponding set of normalized data includes 1,000 entries associated with 1,000 variant calls for the one sequencing result.

15. The method of claim 1, wherein the trigger related to a call review event is associated with at least one of: an assignment of a batch of samples, a creation of denormalized data, a second user request, or a batch loading operation.

16. The method of claim 1, further comprising:
detecting a trigger related to a sample reporting event;
accessing, based on the detected trigger related to a sample reporting event, at least one set of information for facilitating sample reporting.

17. The method of claim 16, wherein accessing at least one set of information for facilitating sample reporting further comprises:
transforming at least one second portion of the denormalized data structure into a second normalized data structure; and
generating at least one sample report based on the second normalized data structure.

18. The method of claim 16, wherein accessing at least one set of information for facilitating sample reporting further comprises:
accessing at least one second portion of the denormalized data structure; and
generating at least one sample report based on the at least one second portion of denormalized data structure.

19. The method of claim 16, wherein accessing at least one set of information for facilitating sample reporting further comprises:
accessing a plurality of normalized data structures; and
generating at least one sample report based on a combination of data from the plurality of normalized data structures.

20. The method of claim 16, wherein accessing at least one set of information for facilitating sample reporting further comprises:
accessing a plurality of denormalized data structures; and
generating at least one sample report based on a combination of data from the plurality of denormalized data structures.

21. A non-transitory computer readable storage medium having instructions stored thereon, the instructions, when executed by one or more processors, cause the processors to perform operations comprising:
detecting a trigger related to a call review event;
accessing, based on the detected trigger, at least one portion of a denormalized data structure;
transforming the at least one portion of the denormalized data structure into a normalized data structure in response to the accessing;
receiving a user request associated with the at least one portion of the denormalized data structure;
accessing the normalized data structure in response to the user request; and
displaying, on a display screen, data contained within the normalized data structure.

22. A system for analyzing a plurality of genomic samples, the system comprising:
a display;
one or more processors; and
a memory storing one or more programs, wherein the one or more programs include instructions configured to be executed by the one or more processors, causing the one or more processors to perform operations comprising:
detecting a trigger related to a call review event;
accessing, based on the detected trigger, at least one portion of a denormalized data structure;
transforming the at least one portion of the denormalized data structure into a normalized data structure in response to the accessing;
receiving a user request associated with the at least one portion of the denormalized data structure;
accessing the normalized data structure in response to the user request; and
displaying, on a display screen, data contained within the normalized data structure.
